(19) United States
(12) Patent Application Publication
(10) Pub. No.: US 2025/0265725 A1
(43) Pub. Date: Aug. 21, 2025

(54) MULTI-FLASH STEREO CAMERA FOR PHOTO-REALISTIC CAPTURE OF SMALL SCENES

(71) Applicants: Toyota Research Institute, Inc., Los Altos, CA (US); Carnegie Mellon University, Pittsburgh, PA (US)

(72) Inventors: Igor Vasiljevic, Pacifica, CA (US); Sergey Zakharov, San Francisco, CA (US); Vitor Guizilini, Santa Clara, CA (US); Rares Ambrus, San Francisco, CA (US); Arkadeep Narayan Chaudhury, Pittsburgh, PA (US)

(73) Assignees: Toyota Research Institute, Inc., Los Altos, TX (US); Toyota Jidosha Kabushiki Kaisha, Toyota-shi Aichi-ken (JP); Carnegie Mellon University, Pittsburgh, PA (US)

(21) Appl. No.: 19/042,629

(22) Filed: Jan. 31, 2025

Related U.S. Application Data
(60) Provisional application No. 63/553,727, filed on Feb. 15, 2024.

(51) Int. Cl. G06T 7/586; G06T 7/579; G06T 7/593; G06T 7/60; G06T 7/90; H04N 13/254

(52) U.S. Cl. CPC G06T 7/586; G06T 7/579; G06T 7/593; G06T 7/60; G06T 7/90; G06T 2207/10012; G06T 2207/10024; G06T 2207/10152; G06T 2207/20081; G06T 2207/20084; H04N 13/254

(57) ABSTRACT

A method may include receiving a plurality of pairs of images of a scene captured by a camera, receiving a pose of the camera when each of the pairs of images of the scene were captured, determining depth values of the scene for each pair of images, and training a neural network to receive a pose of a camera with respect to the scene, and output a geometry of the scene and an appearance of the scene with respect to the pose. The plurality of pairs of images, the poses of the camera, and the depth values may be used as training data to train the neural network. The neural network may include a first component that receives the pose as input, and outputs the geometry of the scene and an embedding, and a second component that receives the embedding as input, and outputs the appearance of the scene.

### CROSS-REFERENCE TO RELATED APPLICATION

The present specification is based on, and claims priority from U.S. Provisional Application No. 63/553,727, filed Feb. 15, 2024, the disclosure of which is hereby incorporated by reference in its entirety.

### TECHNICAL FIELD

The present specification relates to a photorealistic capture of a scene, and more particularly to a multi-flash stereo camera for photo-realistic capture of small scenes.

### BACKGROUND

Synthesizing accurate geometry and photo-realistic appearance of small scenes is an active area of research with compelling use cases in gaming, content creation, virtual reality, and robotics. When applying scene geometry and appearance estimation techniques to robotics, the narrow cone of possible viewpoints due to the limited range of robot motion and scene clutter causes current estimation techniques to produce poor quality estimates. However, in robotic applications, dense metric depth can often be measured directly using stereo, and illumination can be controlled. Depth can provide a good initial estimate of the object geometry to improve reconstruction. Accordingly, a need exists for improved methods of photo-realistic capture of small scenes.

### SUMMARY

In one embodiment, a method may include receiving a plurality of pairs of images of a scene captured by a camera, receiving a pose of the camera when each of the pairs of images of the scene were captured, determining depth values of the scene for each pair of images, and training a neural network to receive a pose of a camera with respect to the scene as input, and output a geometry of the scene and an appearance of the scene with respect to the pose. The plurality of pairs of images, the poses of the camera, and the depth values may be used as training data to train the neural network. The neural network may include a first component that receives the pose as input, and outputs the geometry of the scene and an embedding. The neural network may include a second component that receives the embedding as input, and outputs the appearance of the scene.

In another embodiment, a computing device may comprise one or more processors configured to receive a pose of the camera when each of the pairs of images of the scene were captured, determine depth values of the scene for each pair of images, and training a neural network to receive a pose of a camera with respect to the scene as input, and output a geometry of the scene and an appearance of the scene with respect to the pose. The plurality of pairs of images, the poses of the camera, and the depth values may be used as training data to train the neural network. The neural network may include a first component that receives the pose as input, and outputs the geometry of the scene and an embedding. The neural network may include a second component that receives the embedding as input, and outputs the appearance of the scene

### BRIEF DESCRIPTION OF THE DRAWINGS

The embodiments set forth in the drawings are illustrative and exemplary in nature and are not intended to limit the disclosure. The following detailed description of the illustrative embodiments can be understood when read in conjunction with the following drawings, where like structure is indicated with like reference numerals and in which:

FIG. 1 schematically depicts an architecture of a neural network for capturing a scene for later reconstruction, according to one or more embodiments shown and described herein;

FIG. 2 depicts a schematic diagram of a computing device for capturing a scene for later reconstruction, according to one or more embodiments shown and described herein;

FIG. 3 illustrates a multi-flash stereo camera for photo-realistic capture of small scenes, according to one or more embodiments shown and described herein;

FIG. 4A depicts an example image of a scene captured by the camera of FIG. 3, according to one or more embodiments shown and described herein;

FIG. 4B depicts an example depth image of a scene captured by the camera of FIG. 3;

FIG. 4C shows example depth edges of a scene captured by the camera of FIG. 3;

FIG. 4D shows an example depth gradient image of a scene captured by the camera of FIG. 3;

FIG. 4E shows an example appearance variation of an image captured by the camera of FIG. 3; and

FIG. 5 depicts a flowchart of a method of operating the computing device of FIG. 2, according to one or more embodiments shown and described herein.

### DETAILED DESCRIPTION

The embodiments disclosed herein include a method and system for capturing a scene for later reconstruction. A camera may capture multiple views of the scene from different perspectives and with different lighting conditions. A neural network may then be trained to reconstruct the scene using the captured images as training data. Once it is trained, the neural network may be used to reconstruct an image of the scene from different perspectives. This may have a variety of applications such as gaming, content creation, virtual reality, and robotics. For example, a neural network may be trained to reconstruct a scene in a video game. Then, when a character in the video game approaches the scene, the neural network may be used to generate an image of the scene from the perspective of the video game character, which may change as the character moves around the scene.

In embodiments disclosed herein, dense metric depth is incorporated into the training of neural 3D fields, enabling methods to use dense metric depth with minor changes. An artifact commonly observed while jointly refining shape and appearance is identified and addressed by using depth edges as an additional supervision signal. An accelerated approach is presented for training of neural fields for photo-realistic scene capture and relighting from multi-view and multi-illumination images by incorporating metric depth. In one example, a robot mounted multi-flash stereo camera is used to capture a diverse range of scenes with varying complexity in both appearance and geometry.

In embodiments, the neural network for reconstructing a scene may comprise a combination of two smaller neural networks that are used to capture the shape and appearance of the scene. These two smaller neural networks that comprise the larger neural network are an intrinsic network N(θ) and an appearance network A(ϕ), which are jointly optimized to capture the shape and appearance of the scene, including any objects therein.

The intrinsic network N(θ) may be used to understand intrinsic properties (e.g., geometry) of a scene. The intrinsic network N(θ) may comprise a multi-layer perceptron (MLP) with parameters (θ) with a multi-level hash grid encoding. In one example, the intrinsic network N(θ) has 18 levels of hash grid encodings, with 128 neurons/layer, and a two layer MLP to generate the intrinsic embedding. However, in other examples, other has grid encodings may be used.

The intrinsic network N(θ) may be trained to approximate the intrinsic properties of the scene, which may comprise the scene geometry as a neural signed distance field S(θ) (e.g., depth values) and an embedding ε(θ). The appearance network A(ϕ) may comprise another MLP that takes ε(θ) and a frequency encoded representation of the viewing direction as input, and returns the scene radiance along a ray.

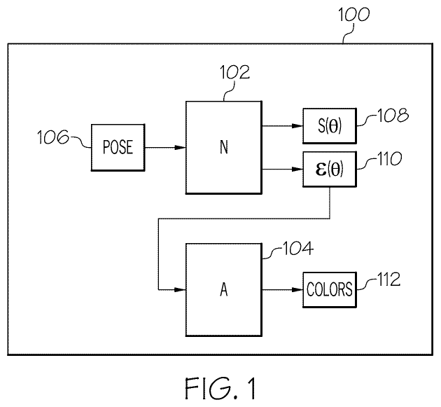

FIG. 1 illustrates an example architecture of a neural network, as disclosed herein. As discussed above, the neural network 100 comprises an intrinsic network N(θ) 102 and an appearance network A(ϕ) 104.

In the illustrated example, the intrinsic network N(θ) 102 has 128 channels, The first channel is the neural signed distance field S(θ), which is trained to recover a signed distance field of the scene, as described in further detail below. The other 127 channels ε(θ) are passed on to the appearance network A(ϕ) 104, as shown in FIG. 1. However, in other examples, the embedding ε(θ) may have any number of channels.

The intrinsic network N(θ) 102 may receive a camera pose 106 as an input and may output a signed distance field S(θ) 108 and an embedding ε(θ) 110, as disclosed herein. The appearance network A(ϕ) 104 may receive the embedding ε(θ) 110 as an input and may output colors along a camera ray 112, which may be used to reconstruct an image of the scene from the input camera pose 106 (e.g., using differentiable volumetric rendering). In some examples, the appearance network A(ϕ) 104 may also receive a viewing direction and/or an illumination direction to generate colors. In the illustrated example, the appearance network A(ϕ) 104 comprises two layers of fully connected MLPS with 128 neurons per layer and skip connections. However, in other examples, the appearance network A(ϕ) 104 may comprise other architectures.

In embodiments, to render an image of a scene from a particular camera pose after the neural network 100 is trained, a frustum of rays are emitted from the camera at the specified pose, and for each ray, a distance to a point in the scene along the ray and a color of the point in the scene may be determined. In embodiments, for a given input camera pose, the intrinsic network N(θ)102 may output the distance to points in the scene for a given camera pose and the appearance network A(ϕ) 104 may output the color, as disclosed herein.

In embodiments, the geometry of a scene is represented with a signed distance field S(θ), which indicates a signed distance of a point from its nearest surface. The signed distance field S(θ) may be optimized to return the signed distance of a point from its nearest surface S(θ): [symbol] → [symbol] . The surface of an object in a scene can be obtained from the zero-level set of S(θ), that is for all surface points xₛ∈ [symbol] |S(xₛ|θ)=0. The intrinsic network N(θ) 102 may be trained to output S(θ), as disclosed herein. In embodiments, the distance of a point \vec{p}=\vec{r}|ₜ_{ᵢ} in a ray to its closest surface sᵢ=S(θ, \vec{p}ᵢ) is transmitted to the scene density (or transmissivity) as follows:

$${Ψ}_{β} ( s ) = \{ \begin{matrix}0.5 exp ( \frac{s}{β} ) , s \leq 0 \\ 1 - 0.5 exp ( \frac{- s}{β} ) , otherwise\end{matrix} \qquad ( 1 )$$

To render the color C of a single pixel of the scene at a target view with a camera centered at \vec{o} and an outgoing ray direction \vec{d}, we may calculate the ray corresponding to the pixel \vec{r}=\vec{o}+t\vec{d}, and sample a set of points tᵢ along the ray. The intrinsic network N(θ) 102 and the appearance network A(ϕ) 104 may then be evaluated at all the xᵢ corresponding to tᵢ and the per point color cᵢ. The transmissivity τᵢ may be obtained and composited together using a quadrature approximation as:

$$C = {\sum }_{i} exp ( - {\sum }_{j < 1} {τ}_{j} {δ}_{j} ) ( 1 - exp ( - {τ}_{j} {δ}_{j} ) ) {c}_{i} , {δ}_{i} = {t}_{i} - {t}_{i - 1} \qquad ( 2 )$$

The appearance can then be learned using a loss on the estimated and ground truth color C_{gt} as:

$${ℓ}_{C} = 𝔼 [ {‖ C - {C}_{gt} ‖}^{2} ] \qquad ( 3 )$$

The appearance and geometry may be jointly estimated using stochastic gradient descent by minimizing the losses in the following equation:

$$ℓ = {ℓ}_{C} + {λ}_{g} {𝔼}_{D} + {λ}_{c} 𝔼 ( \vert {∇}_{x}^{2} S ( {x}_{s} ) \vert ) \qquad ( 4 )$$

In equation (4), λ_{g} and λ_{c} are hyperparameters, and the third term is the mean surface curvature minimized against the captured surface normal. As the gradients of the loss functions [symbol] _{C} and [symbol] _{D} propagate through A and N (and S as it is part of N), the appearance and geometry are learned together.

While S, N, and A may be learned with only multi-view images, in embodiments disclosed herein, the computing device 200 also has access to estimates of true surface depth to any surface point xₛ due to the received depth values, as disclosed herein. Accordingly, in embodiments, the signed distance field S may be directly optimized with depth, as disclosed herein.

Depth estimates can be directly used to optimize appearance and render surfaces. However, to be able to approximate view-dependent appearance, in embodiments disclosed herein, a continuous and locally smooth function is learned that approximates the signed distance function of the surface xₛ, which can then be transformed to scene density, as described above using equation (1). This may be accomplished using the following loss function:

$${ℓ}_{D} ( θ ) = {ℓ}_{{x}_{s}} + λ {𝔼 ( ‖ {∇}_{x} S ( {x}^{Δ} , θ ) ‖ - 1 )}^{2} \qquad ( 5 )$$

where,

$${ℓ}_{{x}_{s}} = \frac{1}{N} {\sum }_{∀ x} [ S ( x , θ ) + 1 - 〈 {∇}_{x} S ( x , θ ) , {n}_{x} 〉 ] .$$

Through the two components of equation (5), the loss encourages the function S(x,θ) to vanish at the observed surface points and the gradients of the surface to align at the measured surface normal. The second component in equation (5) is the Eikonal term, which encourages the gradients of S to have a unit L₂ norm everywhere. The individual terms of equation (5) are average across all samples in a batch corresponding to N rays projected from a known camera.

The Eikonal constraint applies to the neighborhood points xₛ^{Δ} of each point in xₛ. Because the computing device 200 has access to depth maps, as described above, the variance of the neighborhood of xₛ may be identified through a sliding window maximum filter on the depth images. This avoids expensive nearest neighbor lookups for a batch of xₛ to generate better estimates of xₛ^{Δ} at train time. As a result, convergence is accelerated with no loss of accuracy. Because metric depth is used, noisy depth estimates for parts of the scene are implicitly averaged by S optimized by minimizing equation (5), thereby making the disclosed embodiments more robust to errors than methods that do not use depth.

Jointly refining geometry and appearance has the benefits of lesser independent hyperparameters, some degree of geometric super-resolution, and more stable training. However, some pathological cases may arise when a scene has a large variation in appearance corresponding to a minimal variation in geometry across xₛ and xₛ^{Δ}. This effect can be investigated by considering an extreme case of a checkboard printed on matte paper with an inkjet printer, where there is no geometric variation (planar geometry) or view dependent artifacts (ink on matte paper is close to Lambertian) corresponding to a maximum variation in appearance (white on black).

Consider two rays \vec{r}ₓ_{ₛ} and \vec{r}ₓ_{ₛ}_{^{Δ}} connecting the camera center and two neighboring points xₛ and xₛ^{Δ} on two sides of a checkerboard edge included in the same batch of the gradient descent. The total losses for those rays depend on the sum of the geometry and appearance losses. Given unstable hyperparameters, jointly updating both geometry and appearance to minimize a combined loss (e.g., equation 4 above) may result in pathological reconstructions due to [symbol] _{C} gradients dominating over [symbol] _{D}. By gradually increasing the modelling capacity of N, this artifact can be somewhat avoided and the gradient updates can be forced to focus on A to minimize the cumulative loss.

However, if we have per-pixel labels of geometric edges ( [symbol] ), we can preferentially sample image patches with low variation of geometric features when the model capacity is lower (e.g., S(θ) tends to represent smoother surfaces), and focus on image patches with geometric edges when the model capacity has increased. The modelling capacity of A(ϕ) never changes.

Accordingly, in embodiments, a particular sampling procedure may be used when sampling points along camera rays, as disclosed herein. In particular, camera rays can initially be targeted at smoother parts of a scene with no depth edges. Later, camera rays can be targeted at parts of the scene with depth edges. In embodiments, the following equation can be used to draw samples while learning a scene with a variety of geometric and texture edges.

$$P ( {p}_{i} \vert α ) = ( 1 - α ) P ( {p}_{i} ∈ 𝔼 ) + α P ( {p}_{i} ∉ 𝔼 ) \qquad ( 6 )$$

In equation (6), the probability of drawing pixel pᵢ is calculated as a linear blend of the likelihood that it belongs to the set of edge pixels [symbol] and α is a scalar (α∈[0,1]) proportional to the progress of training. To preserve the geometric nature of the edges while ruling out high frequency pixel labels, Euclidean distance transform may be used to dilate [symbol] before applying equation (6).

During training and inference for neural volumetric representations, the slowest step is typically equation (2). However, in one example disclosed herein, training can be accelerated by incorporating metric depth. Training can be made more efficient by drawing the smallest number of the most important samples of tᵢ for any ray. The sampling of tᵢ may be based on the current estimate of the scene density. Although these samples can have a large variance, given a large number of orthogonal view pairs (viewpoint diversity), and the absence of very strong view dependent effects, the training procedure is expected to recover an unbiased estimate of the true scene depth. The convergence can be accelerated by providing high quality biased estimate of the scene depth, and by decreasing the number of samples for tᵢ along the rays.

Given the high quality of modem deep stereo images and a well calibrated camera system, stereo depth can serve as a good initial estimate of the true surface depth. In embodiments, stereo depth aligned across multiple views of the scene are used to pre-optimize the geometry network S(θ). The other channels ε(θ) of Nremain un-optimized. A pre-optimized S can then be used for high quality estimates of ray termination depths.

In some examples, root finding techniques may be used on scene transmissivity (Equation (1)) to estimate the ray termination depth. The samples for Equation (2) may then be generated around the estimated surface point. Drawing high variance samples as N and A are jointly optimized may reduce the effect of low quality local minima, especially in the initial stages of the optimization. As we have a pre-trained scene transmissivity field (S transformed with Equation (1)), we can draw a few high-quality samples to minimize the training effort.

Experiments have shown that uniformly sampling around the estimated ray-termination depth is unsuitable. Instead, in embodiments disclosed herein, a discrete sampling volume is pre-calculated by immersing S in an isotropic voxel grid and culling the voxels which report a lower than threshold scene density. An unbiased sampler may then be used to generate the samples in this volume. This greatly reduces the number of root-finding iterations and samples, while limiting the variance by the dimensions of the volume along a ray. As the training progresses, the culling threshold may be decreased to converge to a thinner sampling volume around the surface while reducing the number of samples required.

In another example, metric depths along the rays are used to optimize the geometry. In particular, the intrinsic network N 102 and the appearance network A 104 may be trained with metric depth and color by minimizing equation (4) above. The samples for equation (3) may be drawn using an error-bounded sampler, as described in ‘Volume rendering of neural implicit surfaces by Yariv, et al. in Advances in Neural Information Processing Systems 34 (2021).

In another example, the training schedule and structure of the intrinsic network N may come from ‘Neuralangelo: High-Fidelity Neural Surface Reconstruction’ by Li, et al. in IEEE Conference on Computer Vision and Pattern Recognition (CVPR). In this example, the appearance network A may be adopted from NeUS as described in ‘Neus: Learning neural implicit surfaces by volume rendering for multi-view reconstruction’ by Wang, et al. in arXiv preprint arXiv:2106.10689 (2021. In this example, an MLP (e.g., with 4 layers, 32 neurons per layer) may learn the radiance of the background.

In another example, the scene's geometry is represented using the pre-optimized intrinsic network N as discussed above. A hyperparameter is used to bias sampling of equation (2) towards the current estimate of the surface as described in ‘Unisurf. Unifying neural implicit surfaces and radiance fields for multi-view reconstruction’ by Oechsel, et al. in Proceedings of the IEEE?CVF International Conference on Computer Vision. 5589-5599. As the surface is pre-optimized, the surface point xₛ=o+tₛd can be found through sphere tracing S along a ray. The intersection point tₛ can then be used to generate N samples along the ray to optimize equation (3).

$${t}_{i} = U \vert {t}_{s} + ( \frac{2 i - 2}{N} - 1 ) Δ , {t}_{s} + ( \frac{2 i}{N} - 1 ) Δ \vert \qquad ( 7 )$$

Equation (7) may be used as the distribution to draw samples and Δ may be the hyperparameter that biases the samples to be close to the current surface estimate. S may be optimized independent of Equation (2) by simply minimizing equation (5) with registered depth maps. This strategy has shown t be highly sensitive to the hyperparameter Δ and its decay scheduled as training progresses.

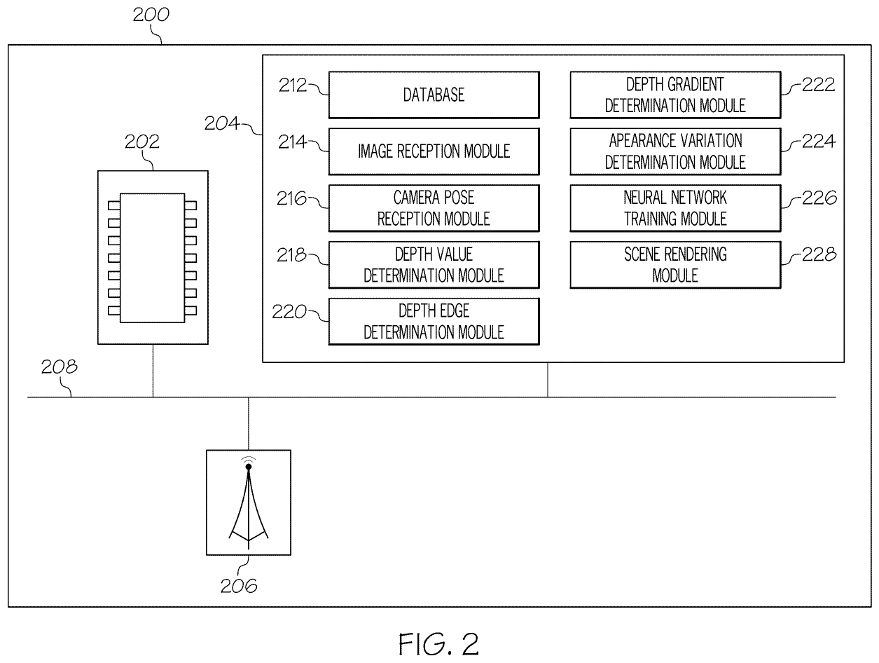

FIG. 2 depicts a computing device 200 for performing photo-realistic capture of small scenes, as disclosed herein. In particular, the computing device 200 may be used to receive images and associated camera poses as training data, and train the neural network 100 as described above.

In the example of FIG. 2, the computing device 200 comprises one or more processors 202, one or more memory modules 204, network interface hardware 206, and a communication path 208. The one or more processors 202 may be a controller, an integrated circuit, a microchip, a computer, or any other computing device. The one or more memory modules 204 may comprise RAM, ROM, flash memories, hard drives, or any device capable of storing machine readable and executable instructions such that the machine readable and executable instructions can be accessed by the one or more processors 202.

The network interface hardware 206 can be communicatively coupled to the communication path 208 and can be any device capable of transmitting and/or receiving data via a network. Accordingly, the network interface hardware 206 can include a communication transceiver for sending and/or receiving any wired or wireless communication. For example, the network interface hardware 206 may include an antenna, a modem, LAN port, Wi-Fi card, WiMax card, mobile communications hardware, near-field communication hardware, satellite communication hardware and/or any wired or wireless hardware for communicating with other networks and/or devices. In one embodiment, the network interface hardware 206 includes hardware configured to operate in accordance with the Bluetooth® wireless communication protocol. The network interface hardware 206 of the computing device 200 may receive images captured by one or more cameras, as disclosed in further detail below.

The one or more memory modules 204 include a database 212, an image reception module 214, a camera pose reception module 216, a depth value determination module 218, a depth edge determination module 220, a depth gradient determination module 222, an appearance variation determination module 224, a neural network training module 226, and a scene rendering module 228. Each of the database 212, the image reception module 214, the camera pose reception module 216, the depth value determination module 218, the depth edge determination module 220, the depth gradient determination module 222, the appearance variation determination module 224, the neural network training module 226, and the scene rendering module 228 may be a program module in the form of operating systems, application program modules, and other program modules stored in the one or more memory modules 204. In some embodiments, the program module may be stored in a remote storage device that may communicate with the computing device 200. Such a program module may include, but is not limited to, routines, subroutines, programs, objects, components, data structures and the like for performing specific tasks or executing specific data types as will be described below.

The database 212 may store images of a scene received from one or more cameras, as well as the camera pose associated with each such image. This data may be stored as training data to train the neural network 100. The database 212 may also store the parameters of the neural network 100.

The image reception module 214 may receive images of a scene captured by one or more cameras. As discussed above, the computing device 200 may receive images of a scene captured by one or more cameras from different angles or perspectives (e.g., from different camera poses). These images may be used as training data to train the neural network 100 to predict an image of the scene for a given camera pose. As such, the image reception module 214 may receive the images of the scene from different camera poses to be used as training data. In the illustrated example, the image reception module 214 receives stereo images captured by a stereo camera with two lenses. The stereo images can be used to determine depth values of pixels in the image, as discussed in further detail below. In other examples, the image reception module 214 may receive monocular images. In some examples where monocular images are received, the image reception module 214 may also receive depth values associated with the images (e.g., captured by a depth sensor).

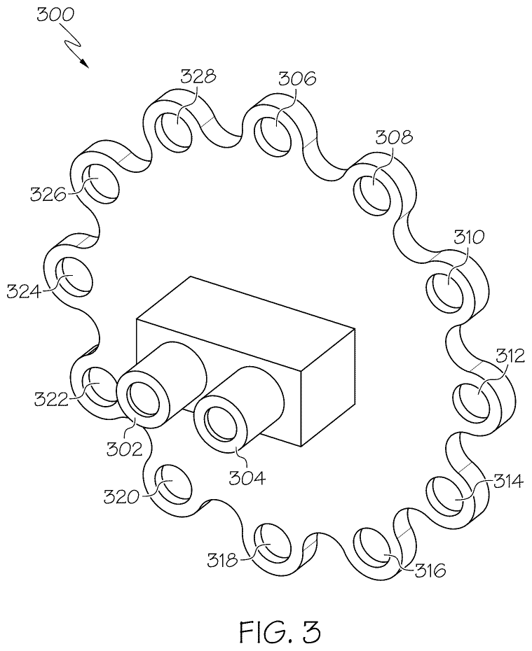

FIG. 3 shows an example camera 300 that may be used to capture images of a scene, as disclosed herein. The camera 300 of FIG. 3 is a multi-flash stereo camera. In particular, the camera 300 comprises two lenses 302 and 304 for capturing stereo images. The camera 300 also comprises twelve lights 306, 308, 310, 312, 314, 316, 318, 320, 322, 324, 326, 328. The lenses 302 and 304 can simultaneously capture stereo images of a scene. The lights 306-328 may be turned on and off in different patterns to illuminate a scene being captured by the lenses 302, 304. As such, images of the scene may be captured with different lighting conditions, thereby increasing the diversity of training data. In one example, each of the twelve lights 306-328 may be turned on and off sequentially in a clockwise or counterclockwise pattern, such that one light is turned on at any given time. For example, for each pose of the camera 300, each lens 302, 304 of the camera 300 may capture twelve images with a different light illuminated for each capture. However, in other examples, the lights 306-328 may be illuminated in any pattern.

In some examples, the camera 300 may move around a scene to capture stereo images of the scene at different angles. For example, the camera 300 may be mounted on a robotic base with wheels such that the camera 300 can move around a scene. The robotic base may move the camera 300 around the scene while the lenses 302, 304 continually capture stereo images of the scene from different angles or perspectives (e.g., every second). The multiple images of the scene captured from different angles and/or different lighting conditions may comprise the training data used to train the neural network 100, as disclosed herein.

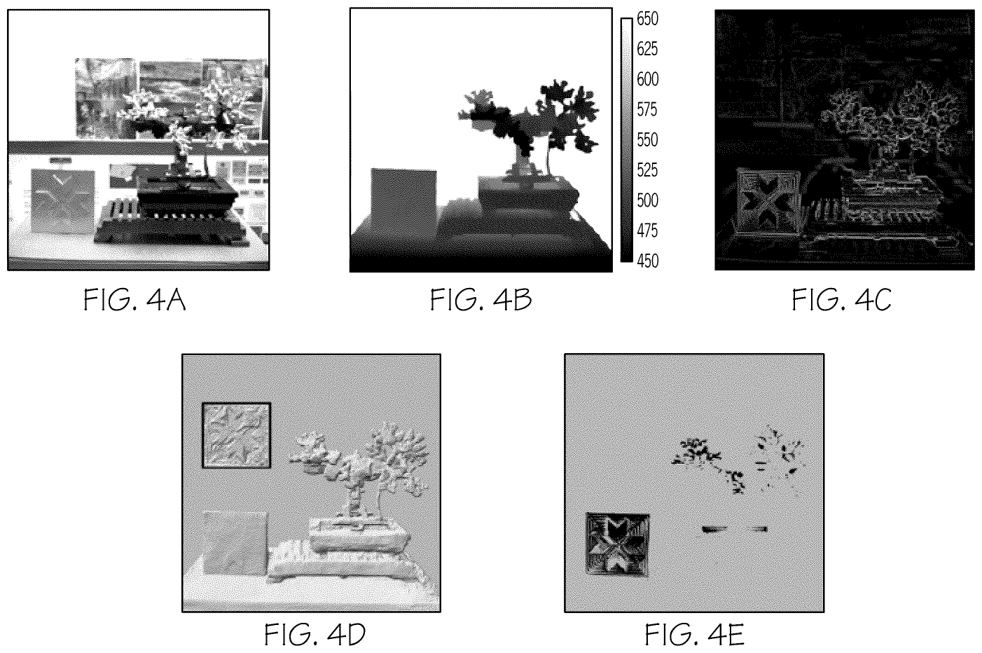

Referring back to FIG. 2, the image reception module 214 may receive a plurality of images of a scene from different camera angles (e.g., stereo images from the camera 300). FIG. 4A shows an example image of a scene that may be received by the image reception module 214. After the image reception module 214 receives the images of the scene, the received images may be stored in the database 212.

Referring still to FIG. 2, the camera pose reception module 216 may receive a camera pose associated with each image received by the image reception module 214. As discussed above, the image reception module 214 may receive a plurality of images of a scene from different camera angles, which are used as training data to train a neural network to predict an image of a scene for a given camera angle. As such, camera pose data is also used as training data. In particular, the camera pose reception module 216 receives data indicating a camera pose of a camera when each image of the scene was captured by the camera.

In the example of FIG. 3, as the camera 300 moves around a scene (e.g., while mounted on a robot), the pose of the camera with respect to the scene may be identified each time that an image is captured by the lenses 302, 304. For example, the camera 300 may include a position sensor that monitors the position and angles of the lenses 302, 304. The camera 300 may then transmit each captured image along with the camera pose to the computing device 200. The image reception module 214 may receive the captured image and the camera pose reception module 216 may receive the camera pose. The images and the associated camera poses may be stored in the database 212, to be used to train the neural network 100, as discussed in further detail below.

Referring still to FIG. 2, the depth value determination module 218 may determine depth values for images received by the image reception module 214. In the illustrated example, the depth value determination module 218 may determine depth values for an image based on received stereo images. For example, for the camera 300 of FIG. 3, the distance between the lens 302 and the lens 304 may be known. As such, for a stereo image of a scene captured by the lens 302 and the lens 304, the depth value determination module 218 may determine the depth value of each pixel in the scene based on the pixel values of the images captured by each lens 302, 304 and the distance between the lenses 302, 304 using known techniques. FIG. 4B shows an example depth image of the image of FIG. 4A. In the example of FIG. 4B, the depth image indicates a depth value of each pixel in millimeters.

Referring still to FIG. 2, the depth edge determination module 220 may determine depth edges for the images received by the image reception module 214. In particular, the depth edge determination module 220 may determine edges based on a depth image determined by the depth value determination module 218. FIG. 4C shows an example image of depth edges for the depth image of FIG. 4B. In particular, FIG. 4C displays the likelihood of each pixel falling on a depth edge.

In one example, per-pixel likelihoods of depth edges may be derived as disclosed herein. Assuming that the flashes of the lights 306, 308, 310, 312, 314, 316, 318, 320, 322, 324, 326, 328 are point light sources and the scene is Lambertian, the observed image intensity can be modeled for the kth light illuminating a point x with reflectance p(x) on the object as:

$${I}_{k} ( x ) = {μ}_{k} ρ ( x ) 〈 {l}_{k} ( x ) , n ( x ) 〉 \qquad ( 8 )$$

where μₖ is the intensity of the kth source and Iₖ(x) is the normalized light vector at the surface point. Iₖ(x) is the image with the ambient component removed. With this, a ratio image across all the illumination sources can be calculated as follows:

$$R ( x ) = \frac{{I}_{k} ( x )}{{I}_{max} ( x )} = \frac{{μ}_{k} 〈 {l}_{k} ( x ) , n ( x ) 〉}{{max}_{i} ( {μ}_{i} 〈 {l}_{i} ( x ) , n ( x ) 〉 )} \qquad ( 9 )$$

It is clear that the ratio image R(x) of a surface point is exclusively a function of the local geometry. As the light source to camera baselines are much smaller than the camera to scene distance, except for a few detached shadows and inter-reflections, the ratio images of equation (9) are more sensitive to the variations in geometry than any other parameters. This fact may be exploited to look for pixels with the largest change in intensity along the direction of the epipolar line between the camera and the light source on the image. This yields a per-light confidence value of whether x is located on a depth edge or not. Across all twelve illumination sources of the camera 300, the maximum values of the confidence may be extracted as the depth edge maps. Parts of the scene may violate the assumption of Lambertian reflectances resulting in spurious depth edges. However, when use depth edges for sampling, these errors do not affect the accuracy of the disclosed pipeline. When using depth edges for enhancing stereo matching, it may be ensured that the stereo pairs do not contain too many of these spurious edge labels to introduce noise into the depth maps.

In some examples, non-Lambertian patches may be identified, as disclosed herein. Assuming uniform Lambertian reflectances, equation (8) can be expanded as:

$${I}_{k} ( x ) = {μ}_{k}^{*} ρ ( x ) {n ( x )}^{T} \frac{{s}_{k} - x}{{\vert {s}_{k} - x \vert}^{3}} \qquad ( 10 )$$

where sₖ is the location and μₖ* is the power of the kth light source. We can define the differential images as

$${I}_{t} = \frac{\partial I}{\partial s} {s}_{t}$$

where

$${s}_{t} = \frac{\partial s}{\partial t} ,$$

which when applied to equation (1), can be expanded as:

$${I}_{t} ( x ) = I ( x ) \frac{{n}^{T} {s}_{t}}{{n}^{T} ( s - x )} - 3 I ( x ) \frac{{( s - x )}^{T} {s}_{t}}{\vert \vert s - {x}^{2}} \qquad ( 11 )$$

Observing that the light sources move in a circle around the center of projection on the imaging plane, s^{T}sₜ=0. Also, the second term of equation (11) is exceedingly small given that the plane spanned by sₜ is parallel to the imaging plane and our choice of lenses limit the field of view of the camera The second term is further attenuated by the denominator |s−x|² because the camera-to-light baselines are at least an order of magnitude smaller than the camera to object distance (x). As a result, under isotropic reflectances (Lambertian assumed for this analysis), the differential images Iₜ(x) are invariant to circular light motions. Any observed variance therefore can be attributed to the violations of isotropic bidirectional reflectance distribution function (BRDF) assumptions. Specular patches can be identified by measuring the variance of this quantity across the twelve instances of the flashing images with the use of camera 300.

Referring still to FIG. 2, the depth gradient determination module 222 may determine a gradient of depth values based on the depth image determined by the depth value determination module 218. In particular, for each pixel of a depth image, the depth gradient determination module 222 determines a gradient depth value of the pixel based on the surrounding pixels using known techniques. FIG. 4D shows an example depth gradient image or surface normal based on the depth image of FIG. 4B.

Referring still to FIG. 2, the appearance variation determination module 224 may determine an appearance variation due to moving lights. FIG. 4E shows an appearance variation due to moving lights of the image of FIG. 4A. In particular, FIG. 4E shows the pixels of the image of FIG. 4A having the largest appearance variation due to moving lights.

Referring still to FIG. 2, the neural network training module 226 may train the neural network 100, as described above. In particular, the neural network training module 126 may train the neural network 100 to receive an input camera pose, and output a predicted image of a scene from that camera pose. As such, the trained neural network 100 may be used to generate an image of a particular scene from any camera pose.

Referring still to FIG. 2, the scene rendering module 228 may render an image of the scene from a specified pose using the trained neural network 100. In particular, the scene rendering module 228 may receive a camera pose from which to generate an image of the scene. The camera pose may be input to the neural network 100. The intrinsic network N 102 may output the signed distance field S 108 and the appearance network A 104 may output colors 112 for the pixels of the scene. The scene rendering module 228 may then render an image of the scene based on the output signed distance field S 108 and the output colors 112.

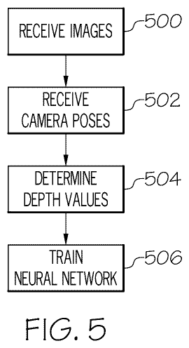

FIG. 5 depicts a flowchart of an example method for operating the computing device 200 for performing photo-realistic capture of small scenes. At step 500, the image reception module 214 receives images from a camera. In particular, in the illustrated example, the image reception module 214 receives a plurality of pairs of images of a scene captured by the camera 300. The pairs of images may be captured by the stereo lenses 302, 304.

At step 502, the camera pose reception module 216 receives camera poses associated with the images received by the image reception module 214. In particular, the camera pose reception module 216 receives a camera pose associated with each pair of images captured by the image reception module 214.

At step 504, the depth value determination module 218 determines depth values of the scene for each pair of images. In particular, for each pair of stereo images received by the image reception module 214, the depth value determination module 218 determines depth values for the pixels in the scene based on the stereo images.

Ag step 506, the neural network training module 226 trains the neural network 100 using the techniques described above. In particular, the neural network training module 226 trains the neural network 100 to receive a pose of a camera with respect to the scene as input, and output a geometry of the scene and an appearance of the scene with respect to the pose, using the images received by the image reception module 214, the camera poses received by the camera pose reception module 216, and the depth values determined by the depth value determination module 218 as training data.

It should now be understood that embodiments described herein are directed to a multi-flash stereo camera for photo-realistic capture of small scenes. A neural network can be trained to render an image of a scene using a plurality of images of the scene captured from different camera poses. The neural network may comprise an intrinsic network to represent geometry and an appearance network to represent an appearance of the scene. The camera may capture stereo images such that metric depth values for the images of the scene can be determined and used during training of the neural network. After the neural network is trained, a camera pose may be input to the trained neural network and an image of the scene from the perspective of the input camera pose may be rendered based on the output of the neural network.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method comprising:
receiving a plurality of pairs of images of a scene captured by a camera;
receiving a pose of the camera when each of the pairs of images of the scene were captured;
determining depth values of the scene for each pair of images; and
training a neural network to receive a pose of a camera with respect to the scene as input, and output a geometry of the scene and an appearance of the scene with respect to the pose, using the plurality of pairs of images, the poses of the camera, and the depth values as training data;
wherein the neural network comprises a first component that receives the pose as input, and outputs the geometry of the scene and an embedding; and
wherein the neural network comprises a second component that receives the embedding as input, and outputs the appearance of the scene.

2. The method of claim 1, wherein the geometry of the scene comprises a signed distance field indicating a signed distance of each point in the scene to a nearest surface of an object in the scene.

3. The method of claim 2, further comprising:
training the neural network to minimize a loss function over the training data, the loss function comprising a component based on a difference between the depth values and values of the signed distance field.

4. The method of claim 1, wherein the appearance of the scene comprises a color of each pixel of each object in the scene.

5. The method of claim 4, further comprising:
training the neural network to minimize a loss function over the training data, the loss function comprising a component based on a difference between the output color of each pixel of each object in the scene and ground truth values of the color of each pixel of each object in the scene based on the images of the scene.

6. The method of claim 1, further comprising:
determining per-pixel likelihoods of geometric edges of objects in the images; and
sampling pixels along camera rays with a distribution such that the probability of sampling a pixel is proportional to the likelihood that the pixel belongs to a geometric edge of the object, and is proportional to a value based on progress of the training of the neural network.

7. The method of claim 1, wherein the first component of the neural network comprises a multi-layer perceptron.

8. The method of claim 1, wherein the second component of the neural network comprises a multi-layer perceptron with skip connections.

9. The method of claim 1, further comprising:
receiving the plurality of pairs of images of the scene captured by a camera comprising a plurality of lights;
wherein the camera captures multiple pairs of images at each camera of a plurality of camera poses, with a different configuration of illumination of the plurality of lights at each camera pose.

10. The method of claim 1, further comprising, after training the neural network:
receiving a camera pose;
inputting the camera pose to the neural network; and
rendering an image of the scene based on outputs of the first component of the neural network and the second component of the neural network.

11. A computing device comprising one or more processors configured to:
receive a plurality of pairs of images of a scene captured by a camera;
receive a pose of the camera when each of the pairs of images of the scene were captured;
determine depth values of the scene for each pair of images; and
train a neural network to receive a pose of a camera with respect to the scene as input, and output a geometry of the scene and an appearance of the scene with respect to the pose, using the plurality of pairs of images, the poses of the camera, and the depth values as training data;
wherein the neural network comprises a first component that receives the pose as input, and outputs the geometry of the scene and an embedding; and
wherein the neural network comprises a second component that receives the embedding as input, and outputs the appearance of the scene.

12. The computing device of claim 11, wherein the geometry of the scene comprises a signed distance field indicating a signed distance of each point in the scene to a nearest surface of an object in the scene.

13. The computing device of claim 12, wherein the one or more processors are further configured to:
train the neural network to minimize a loss function over the training data, the loss function comprising a component based on a difference between the depth values and values of the signed distance field.

14. The computing device of claim 11, wherein the appearance of the scene comprises a color of each pixel of each object in the scene.

15. The computing device of claim 14, wherein the one or more processors are further configured to:
train the neural network to minimize a loss function over the training data, the loss function comprising a component based on a difference between the output color of each pixel of each object in the scene and ground truth values of the color of each pixel of each object in the scene based on the images of the scene.

16. The computing device of claim 11, wherein the one or more processors are further configured to:
determine per-pixel likelihoods of geometric edges of objects in the images; and
sample pixels along camera rays with a distribution such that the probability of sampling a pixel is proportional to the likelihood that the pixel belongs to a geometric edge of the object, and is proportional to a value based on progress of the training of the neural network.

17. The computing device of claim 11, wherein the first component of the neural network comprises a multi-layer perceptron.

18. The computing device of claim 11, wherein the second component of the neural network comprises a multi-layer perceptron with skip connections.

19. The computing device of claim 11, wherein the one or more processors are further configured to:
receive the plurality of pairs of images of the scene captured by a camera comprising a plurality of lights;
wherein the camera captures multiple pairs of images at each camera of a plurality of camera poses, with a different configuration of illumination of the plurality of lights at each camera pose.

20. The computing device of claim 11, wherein the one or more processors are further configured to, after training the neural network:
receive a camera pose;
input the camera pose to the neural network; and
render an image of the scene based on outputs of the first component of the neural network and the second component of the neural network.
